(19) United States
(12) Patent Application Publication
(10) Pub. No.: US 2021/0197769 A1
(43) Pub. Date: Jul. 1, 2021

(54) VEHICLE CLEANING SYSTEM

(71) Applicant: DENSO CORPORATION, Kariya-city, Aichi-pref (JP)

(72) Inventors: Daisuke SHIRAKURA, Kariya-city (JP); Yuusuke YAMAUCHI, Kariya-city (JP); Shigehisa HAMAGUCHI, Kariya-city (JP)

(73) Assignee: DENSO CORPORATION, Kariya-city, Aichi-pref (JP)

(21) Appl. No.: 16/754,442

(22) PCT Filed: Oct. 9, 2018
(86) PCT No.: PCT/JP2018/037614

§ 371 Date: Apr. 8, 2020

(30) Foreign Application Priority Data
Oct. 10, 2017 (JP) 2017-197285
Dec. 12, 2017 (JP) 2017-237729
Dec. 12, 2017 (JP) 2017-237731

(51) Int. Cl. B60S 1/48

(52) U.S. Cl. CPC B60S 1/486; B60R 16/00; B60S 1/481

(57) ABSTRACT

A vehicle cleaning system includes plural cleaning sections configured to clean cleaning targets including a sensor face of an optical sensor installed to a vehicle, and a control section capable of automatically controlling the cleaning sections. The control section is configured to control a priority ranking for actuation of the cleaning sections in response to a travel situation and/or an environmental situation of the vehicle in cases in which a cleaning request has been made for the cleaning sections.

### TECHNICAL FIELD

The present disclosure relates to a system for cleaning various cleaning targets installed to a vehicle.

### BACKGROUND ART

Development of technology to install driving assistance systems to vehicles has been progressing in recent years. To install a driving assistance system in a vehicle, various onboard sensors are required in order to detect travel states of the vehicle. Such onboard sensors include internally installed vehicle sensors such as GPS, acceleration sensors, gyroscopic sensors, temperature sensors, level sensors, speed sensors, revolution speed sensors, travel distance sensors, and driving operation detectors, as well as radar to detect states in the vehicle surroundings using radio waves such as millimeter wave radar, and optical sensors used to detect vehicle travel states, travel lanes, road signs, travel demarcation lines, other vehicles, obstacles external to the vehicle, and so on.

Adhered material such as dirt (for example mud) or water droplets may adhere to lens faces of onboard sensors or transparent covers or glass (sensor faces or sensing faces) in front thereof. When adhered material adheres to front or rear windshields, such adhered material can be removed since cleaning devices such as washers, wipers, and the like are attached. However, in cases in which adhered material adheres to the lens faces of the onboard sensors or covers in front thereof disposed at the vehicle exterior, the detection performance of these onboard sensors may suffer. Technology has therefore been proposed for cleaning lens faces and covers of onboard sensors.

Japanese Patent Application Laid-Open (JP-A) No. 2015-224032 discloses technology to remove dirt that has adhered to a lens face of an optical sensor. In the technology disclosed in JP-A No. 2015-224032, cleaning water is sprayed under pressure through a liquid nozzle toward the lens face of the optical sensor to clean dirt from the lens face. Air is then blown under pressure through an air nozzle to dry the cleaning water remaining on the lens face. This technology employs a common liquid pump for generating both pressurized cleaning water and pressurized air.

A known related vehicle cleaning system is configured including a washer device including a washer nozzle that sprays cleaning liquid onto a wiping surface, a washer pump that supplies the cleaning liquid to the washer nozzle, and a washer tank that stores the cleaning liquid. In this related vehicle cleaning system, a liquid amount measuring section (for example a float, a variable resistor, or a liquid surface sensor) is provided to the washer tank to measure whether or not the amount of cleaning liquid in the washer tank is a predetermined amount or lower. When the liquid amount measuring section detects that the liquid amount is the predetermined amount or lower, a warning lamp is illuminated to notify an occupant that the liquid amount of the cleaning liquid is insufficient (see JP-A No. 2007-045392).

### SUMMARY OF INVENTION

### Technical Problem

Vehicles installed with driving assistance systems are installed with numerous onboard sensors. Of these onboard sensors, if adhered material adheres to the lens faces or covers of optical sensors, the detection performance of the optical sensors may particularly suffer. The technology of JP-A No. 2015-224032 discusses cleaning a single optical sensor. However, the technology of JP-A No. 2015-224032 is not intended to be applied to cleaning numerous onboard sensors including optical sensors, and as such it would be difficult to employ such technology in its current form in a vehicle installed with a driving assistance system.

Namely, onboard sensors are placed so as to be distributed at the vehicle exterior and the vehicle interior, for example being widely distributed to a front grille, front corners, an inner face of a front windshield, the sides, the rear, a rear section, and an inner face of a rear windshield. Frequent cleaning of all of these onboard sensors would consume a large amount of cleaning liquid. Since washer tank capacity is limited, an increase in the amount of cleaning liquid used could cause a shortage of cleaning liquid during travel. In particular, in the case of vehicles installed with a driving assistance system, if a cleaning liquid shortage arises, there is a possibility that the detection performance of the onboard sensors may suffer, which might cause driving assistance errors.

In cases in which cleaning of all of a large number of cleaning targets is desired, the cleaning targets are cleaned in sequence. However, depending on the number of cleaning targets, a duration of from several seconds to several tens of seconds may be required from starting cleaning until cleaning of the last cleaning target is completed. Such a delay in cleaning is undesirable when cleaning safety-critical sensors such as collision avoidance sensors.

In JP-A No. 2015-224032, the cleaning system is manually actuated by a user. However, it is difficult for a user to judge the dirtiness of each cleaning target when numerous cleaning targets are present. Therefore, when cleaning commands are issued manually, there is a tendency to clean multiple cleaning targets. Conceivably, control devices might be provided to automatically actuate the cleaning devices in each section by performing automated control of the cleaning devices in each section. In such cases, too, for example when a vehicle is started up after having been parked for an extended period, or when mud is flicked up in large quantities when traveling on rough roads in wet weather, cleaning commands may be issued for multiple cleaning targets at once. In such cases, the multiple cleaning targets are cleaned in sequence, such that the above-described cleaning takes time.

The present disclosure provides a vehicle cleaning system capable of automatically cleaning plural cleaning targets installed to a vehicle, and capable of setting an appropriate cleaning priority ranking for the respective cleaning targets in response to a travel situation or an environmental situation in cases in which cleaning requests have been issued to plural cleaning sections.

In particular, in vehicles provided with multiple onboard optical sensors, the amount of cleaning liquid used increases with the number of detection faces of the onboard optical sensors that configure cleaning targets. Simply notifying of a cleaning liquid shortage as hitherto increases the probability of a situation arising in which cleaning liquid is not available when desired. Moreover, in cases in which a vehicle is installed with an automated cleaning system as a driving assistance system, since cleaning liquid is sprayed automatically onto dirt on the onboard optical sensors, the cleaning liquid is used without the driver knowing. Since the driver does not have a sense of how much cleaning liquid is being used, this could result in the driver being notified of a cleaning liquid shortage at unexpected timings.

The present disclosure provides a vehicle cleaning system that enables a driver or occupant to replenish cleaning liquid appropriately in a vehicle provided with multiple onboard optical sensors.

Furthermore, in cases such as that described above in which cleaning devices corresponding to respective onboard sensors are automatically controlled, a control device is required in order to automatically actuate the cleaning devices corresponding to the respective onboard sensors. Conceivably, a control device such as an Advanced Driver Assistance System Electronic Control Unit (ADAS-ECU) might be employed to control the aforementioned cleaning devices. In such cases, since the ADAS-ECU would already be used for a wide range of control processing necessary for driving assistance, it would not be desirable for the ADAS-ECU to also perform computation processing relating to the cleaning system in consideration of the load on the ADAS-ECU. Moreover, were cleaning system processing to be concentrated in the ADAS-ECU, this would necessitate still more additional electric wiring for the cleaning system. Such significant additional electric wiring is undesirable for the ADAS-ECU, where electric wiring is already heavily concentrated.

The present disclosure provides a vehicle cleaning system capable of automatic cleaning of cleaning targets including plural onboard sensors installed to a vehicle while avoiding a heavy concentration of wiring at a control device.

The present disclosure also provides a vehicle cleaning system enabling wiring and tubing to be omitted.

### Solution to Problem

A first aspect of the present disclosure is a vehicle cleaning system including plural cleaning sections configured to clean cleaning targets including a sensor face of an optical sensor installed at a vehicle, and a control section capable of automatically controlling the cleaning sections. The control section is configured to control a priority ranking for actuation of the cleaning sections in response to at least one of a travel situation or an environmental situation of the vehicle, in a case in which a cleaning request has been made for the cleaning sections.

A vehicle cleaning system of a second aspect of the present disclosure is the first aspect, wherein the control section is configured to actuate the cleaning sections in sequence according to the priority ranking in cases in which cleaning requests have been made for the plural cleaning sections at substantially the same time.

A vehicle cleaning system of a third aspect of the present disclosure is the first or the second aspect, further including an adhered material detection section configured to detect an adherence state of adhered material to the cleaning targets. The control section is configured to assess the cleaning request and control the cleaning sections based on an adhered material detection signal from the adhered material detection section.

A vehicle cleaning system of a fourth aspect of the present disclosure is the third aspect, wherein an alert is issued in cases in which the adhered material detection signal has been emitted by the adhered material detection section after cleaning has been performed a predetermined number of times or greater within a predetermined duration.

A vehicle cleaning system of a fifth aspect of the present disclosure is any one of the first to the fourth aspects, wherein the control section is configured to control the priority ranking in response to a direction of progress of the vehicle.

A vehicle cleaning system of a sixth aspect of the present disclosure is any one of the first to the fifth aspects, wherein the control section is configured to control the priority ranking in response to weather information.

A vehicle cleaning system of a seventh aspect of the present disclosure is any one of the first to the sixth aspects, wherein the control section is configured to control the priority ranking in response to a travel speed of the vehicle.

A vehicle cleaning system of an eighth aspect of the present disclosure is any one of the first to the seventh aspects, wherein the control section is configured to control the priority ranking in response to a travel route of the vehicle.

A vehicle cleaning system of a ninth aspect of the present disclosure is any one of the first to the eighth aspects, wherein the control section is configured to control an actuation pattern of the cleaning sections.

A vehicle cleaning system of a tenth aspect of the present disclosure is the ninth aspect, wherein each cleaning section includes a sprayer section configured to spray a fluid toward a corresponding cleaning target, and the actuation pattern includes a spraying period and a rest period of the fluid.

A vehicle cleaning system of an eleventh aspect of the present disclosure is any one of the first to the tenth aspects, wherein each cleaning section further includes a washer nozzle configured to spray cleaning liquid toward a corresponding cleaning target, a washer pump configured to supply the cleaning liquid to the washer nozzle, a washer tank configured to hold the cleaning liquid internally, a liquid level detection section configured to detect a remaining level of the cleaning liquid in the washer tank, and a remaining level display section configured to display the remaining level of the cleaning liquid in the washer tank as detected by the liquid level detection section.

A vehicle cleaning system of a twelfth aspect of the present disclosure is the eleventh aspect, wherein the remaining level display section exhibits a hysteresis property when displaying the remaining level of the cleaning liquid in the washer tank as detected by the liquid level detection section.

A vehicle cleaning system of a thirteenth aspect of the present disclosure is the eleventh or the twelfth aspect, further including a first alert section configured to compute a predicted consumption amount of the cleaning liquid corresponding to a travel distance to an input destination, and to issue an alert in a case in which the remaining level of the cleaning liquid is insufficient compared to the predicted consumption amount of the cleaning liquid, or in a case in which a predetermined remaining level value or lower will be reached.

A vehicle cleaning system of a fourteenth aspect of the present disclosure is any one of the eleventh to the thirteenth aspects, further including a second alert section configured to issue alerts in plural stages in response to the remaining level of the cleaning liquid.

A vehicle cleaning system of a fifteenth aspect of the present disclosure is the fourteenth aspect, wherein the second alert section issues different alerts corresponding to the remaining level of the cleaning liquid.

A vehicle cleaning system of a sixteenth aspect of the present disclosure is any one of the first to the fifteenth aspects, wherein the control section is provided separately from a driving assistance control device that performs computation processing on signals from the optical sensor.

A vehicle cleaning system of a seventeenth aspect of the present disclosure is the sixteenth aspect, wherein plural of the control sections are provided in a distributed placement.

A vehicle cleaning system of an eighteenth aspect of the present disclosure is the seventeenth aspect, wherein the control sections are placed so as to be at least distributed at a vehicle front and a vehicle rear.

A vehicle cleaning system of a nineteenth aspect of the present disclosure is any one of the sixteenth to the eighteenth aspects, wherein the control section doubles as a wiper control device.

A vehicle cleaning system of a twentieth aspect of the present disclosure is any one of the first to the sixteenth aspects, wherein the vehicle is installed with a driving assistance device or an autonomous driving device.

### Advantageous Effects of Invention

In the vehicle cleaning system of the first aspect of the present disclosure, providing the control section that is capable of automatically controlling the cleaning sections enables the plural cleaning targets installed to the vehicle (including the sensor face of the optical sensor) to be automatically cleaned. In cases in which a cleaning request has been made for the cleaning sections, the control section controls a priority ranking for actuation of the cleaning sections in response to the travel situation and/or the environmental situation of the vehicle. This enables the cleaning targets to be cleaned in sequence from the highest priority level based on an always-appropriate priority ranking in response to the travel situation and/or the environmental situation of the vehicle. Furthermore, only cleaning targets that require automatic cleaning are cleaned, thereby enabling the cleaning liquid consumption amount of the vehicle to be suppressed.

In the vehicle cleaning system of the second aspect of the present disclosure, the cleaning sections can be actuated in sequence according to the predetermined priority ranking in cases in which cleaning requests have been made for the plural cleaning sections at substantially the same time. This enables cleaning targets with a higher priority level to always be swiftly cleaned, even in cases in which multiple cleaning requests coincide with each other. This enables a deterioration in detection performance of the optical sensor and so on that are necessary for driving assistance due to adhered material to be suppressed in vehicles installed with driving assistance systems in particular, thereby enabling an effect on driving assistance to be suppressed.

In the vehicle cleaning system of the third aspect of the present disclosure, the control section assesses the cleaning request and controls the cleaning sections based on the adhered material detection signal from the adhered material detection section, thereby enabling only the required cleaning sections to be actuated at the required cleaning degree. This enables cleaning liquid consumption to be reduced, while maintaining a state in which there is no adhered material on the cleaning targets such as the optical sensor (a state in which the optical sensor and so on can be suitably utilized).

In the vehicle cleaning system of the fourth aspect of the present disclosure, the alert is informed in cases in which the adhered material detection signal has been issued by the adhered material detection section even though cleaning has been performed the predetermined number of times or greater within the predetermined duration. This enables a driver to be advised by this alert that a particular cleaning target requires manual cleaning.

In the vehicle cleaning system of the fifth aspect of the present disclosure, the control section controls the priority ranking of the respective cleaning targets of the vehicle that require cleaning in response to the direction of progress of the vehicle. This enables the cleaning targets to be cleaned based on an always-appropriate priority ranking, regardless of the direction of progress of the vehicle.

In the vehicle cleaning system of the sixth aspect of the present disclosure, the control section controls the priority ranking of the respective cleaning targets of the vehicle that require cleaning in response to the weather information. This enables the cleaning targets to be cleaned based on an always-appropriate priority ranking, regardless of the weather.

In the vehicle cleaning system of the seventh aspect of the present disclosure, the control section controls the priority ranking of the respective cleaning targets of the vehicle that require cleaning in response to the travel speed of the vehicle. This enables the cleaning targets to be cleaned based on an always-appropriate priority ranking, regardless of the travel speed of the vehicle.

In the vehicle cleaning system of the eighth aspect of the present disclosure, the control section controls the priority ranking of the respective cleaning targets of the vehicle that require cleaning in response to the travel route of the vehicle. This enables the cleaning targets to be cleaned based on an always-appropriate priority ranking, regardless of the travel route of the vehicle.

In the vehicle cleaning system of the ninth aspect of the present disclosure, the control section is able to control the actuation pattern of the cleaning sections, thereby enabling the degree of cleaning to be appropriately set. This enables adhered material on the cleaning targets to be suitably removed.

In the vehicle cleaning system of the tenth aspect of the present disclosure, the actuation pattern of the cleaning sections includes the fluid (cleaning liquid or air) spraying period and the rest period. This enables the fluid spraying period and rest period to be combined to set various cleaning patterns, thereby enabling appropriate cleaning to be performed in response to the degree of cleaning required.

The vehicle cleaning system of the eleventh aspect of the present disclosure includes the remaining level display section that displays the remaining cleaning liquid level in the washer tank. Thus, the driver or another occupant is able to check the remaining cleaning liquid level, and is able to replenish the cleaning liquid in a timely manner in cases in which a cleaning liquid shortage is predicted. This enables a situation in which a remaining cleaning liquid level shortage prevents use of the cleaning liquid to be suppressed.

In the vehicle cleaning system of the twelfth aspect of the present disclosure, the remaining level display section exhibits a hysteresis property when displaying the remaining cleaning liquid level in the washer tank as detected by the liquid level detection section. This enables variations in the remaining level display due to the cleaning liquid moving around when the vehicle sways or tilts to be suppressed.

In the vehicle cleaning system of the thirteenth aspect of the present disclosure, when the destination is input to a car navigation system for example, the predicted cleaning liquid consumption amount is known in based on the travel distance and so on, and so whether or not the remaining cleaning liquid level is insufficient compared to the predicted consumption amount is also known. Note that the alert is issued in cases in which the remaining cleaning liquid level is insufficient compared to the predicted cleaning liquid consumption amount or in cases in which the predetermined remaining level value or lower will be reached, thereby enabling the driver or other occupant to replenish the cleaning liquid in response thereto.

In the vehicle cleaning system of the fourteenth aspect of the present disclosure, the alerts are issued in plural stages in response to the remaining cleaning liquid level, for example the alerts are issued when the remaining cleaning liquid level reaches 50%, 30%, and 10%. This enables the driver or other occupant to check the level of urgency of cleaning liquid replenishment at an appropriate timing.

In the vehicle cleaning system of the fifteenth aspect of the present disclosure, different alerts are issued corresponding to the remaining cleaning liquid level, for example different alerts are issued when the remaining cleaning liquid level reaches 50%, 30%, and 10%. This enables the driver or other occupant to ascertain the level of urgency of cleaning liquid replenishment based on the type of alert.

In the vehicle cleaning system of the sixteenth aspect of the present disclosure, the cleaning targets including plural onboard sensors (sensor faces (sensing faces) of the onboard sensors) installed in the vehicle can be cleaned autonomously by autonomously controlling the cleaning sections. Moreover, providing the control section for autonomous cleaning separately to the driving assistance control device (ADAS-ECU) enables a heavy concentration of wiring to be avoided.

In the vehicle cleaning system of the seventeenth aspect of the present disclosure, the plural control sections are provided in a distributed placement, thereby enabling a concentration of wiring at the control sections to be further reduced. The distance of the wiring between the control sections and the cleaning sections can also be shortened.

In the vehicle cleaning system of the eighteenth aspect of the present disclosure, the control sections are placed so as to be distributed at the vehicle front and the vehicle rear. Thus, cleaning of the cleaning targets at the vehicle front is handled by the front control section and cleaning of the cleaning targets at the vehicle rear is handled by the rear control section. Thus, control of the respective cleaning devices is appropriately distributed, and wiring is more easily omitted.

In the vehicle cleaning system of the nineteenth aspect of the present disclosure, the control section to clean the cleaning targets doubles as a wiper control device, thereby enabling the number of control devices (ECUs) to be reduced without increasing the computational load on the ADAS-ECU.

The vehicle cleaning system of the twentieth aspect of the present disclosure enables a vehicle optical device cleaning system appropriate for the driving assistance device or the autonomous driving device to be provided. Namely, by controlling the priority ranking for actuating the cleaning sections in response to the travel situation and/or the environmental situation of the vehicle, a deterioration in detection performance of the optical sensor and so on that are always in high requirement due to adhered material can be suppressed, and an irregular end to autonomous driving arising due to a deterioration in the detection performance of the respective sensors can be avoided.

### BRIEF DESCRIPTION OF DRAWINGS

FIG. 1 is a schematic plan view illustrating a vehicle cleaning system according to a first exemplary embodiment.

FIG. 2 is a block diagram illustrating a priority ranking of cleaning targets in an Example 1 (when a vehicle is driving forward) of the first exemplary embodiment.

FIG. 3 is a block diagram illustrating a priority ranking of cleaning targets in an Example 2 (when a vehicle is reversing) of the first exemplary embodiment.

FIG. 4A is a diagram illustrating an example of a display on a remaining level display section according to a second exemplary embodiment.

FIG. 4B is a diagram illustrating an example of a display on a remaining level display section according to the second exemplary embodiment when a remaining cleaning liquid level is a predetermined value or greater.

FIG. 4C is a diagram illustrating an example of an emphatic display on a remaining level display section according to the second exemplary embodiment when a remaining cleaning liquid level is less than a predetermined value.

FIG. 5 is a diagram illustrating basic configuration of a modified example of the second exemplary embodiment.

FIG. 6 is a block diagram illustrating an example of hardware configuration of respective devices according to the modified example of the second exemplary embodiment.

FIG. 7 is a schematic plan view illustrating a vehicle cleaning system according to a comparative example corresponding to a third exemplary embodiment.

### DESCRIPTION OF EMBODIMENTS

### First Exemplary Embodiment

Detailed explanation follows regarding a vehicle cleaning system according to a first exemplary embodiment of the present disclosure, with reference to the drawings. The exemplary embodiment described below uses the example of a vehicle with an autonomous driving system as one example of a specific implementation of the technical concept of the present disclosure, and is not intended to limit the present disclosure to this embodiment. The present disclosure may equally be applied to a vehicle cleaning system of a vehicle provided with cleaning targets such as an optical sensor even in cases in which an autonomous driving system is not provided.

Explanation will first be given regarding autonomous driving levels in order to assist understanding of the present disclosure. Autonomous driving is classified into the following levels, as defined in SAE J3016 of SAE international (a U.S. non-profit organization for mobility experts).

Level 0: No driving automation
Level 1: Driving assistance
Level 2: Partial driving automation
Level 3: Conditional autonomous driving
Level 4: High level autonomous driving
Level 5: Full autonomous driving

Level 0 vehicles are vehicles requiring the driver to perform all driving operations, and correspond to general vehicles not provided with a driving automation system. Level 1 vehicles are vehicles in which a driving automation system performs either steering wheel operation or acceleration and deceleration control of the vehicle, while other operation is performed by the driver. In level 1 vehicles, the driver controls the vehicle as appropriate in response to events in the surroundings, and monitoring of autonomous driving system operation is required. Level 1 vehicles correspond to vehicles with adaptive cruise control functionality (devices to perform travel at a constant speed or control inter-vehicle distance). Level 2 vehicles are vehicles in which a driving automation system performs both steering wheel operation and acceleration and deceleration control, while other operation is performed by the driver. In level 2 vehicles, the driver controls the vehicle in response to situations in the surroundings, and monitoring of autonomous driving system operation is required.

Level 3 to level 5 vehicles are classified as vehicles provided with what is referred to as an autonomous driving system. Level 3 vehicles are vehicles in which a driving automation system performs all driving operation in accordance with the situation in the surroundings, but requires driver intervention in emergencies. Level 4 vehicles are vehicles in which a driving automation system performs all driving operation in accordance with the situation in the surroundings, and driver intervention is not expected. Although dependent on the surrounding environment, level 4 vehicles are fundamentally capable of unmanned driving. Level 5 vehicles are vehicles in which a driving automation system performs all driving operation in accordance with the situation in the surroundings unconditionally, and are capable of fully unmanned driving.

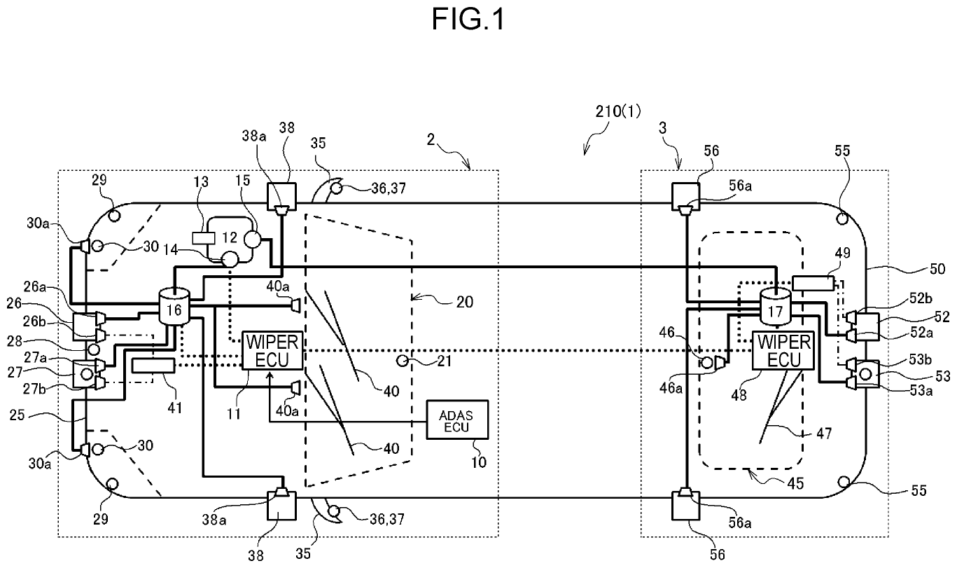

Explanation follows regarding the vehicle cleaning system of the vehicle of the first exemplary embodiment, with reference to FIG. 1. FIG. 1 is a schematic plan view illustrating the vehicle cleaning system of the first exemplary embodiment.

In FIG. 1, a vehicle 210 of the first exemplary embodiment includes a vehicle cleaning system 1. In FIG. 1, the bold solid lines represent washer hoses, the bold dashed lines represent power source lines or signal lines, and the single-dotted dashed lines represent air hoses.

The vehicle cleaning system 1 in FIG. 1 is configured by a front control section 2 and a rear control section 3. First, explanation follows regarding cleaning sections of the front control section 2.

A front camera 21 is disposed at an upper inside portion of a front windshield 20 of the vehicle 210. The front camera 21 is installed at a back side of a rear view mirror at the top of the front windshield 20 inside a vehicle cabin, so as to face ahead of the vehicle 210 to perform forward capture through the glass of the front windshield 20. Image recognition processing is performed on images captured by the front camera 21 either in an image processor installed within the front camera 21, or after being transmitted to an ADAS-ECU. Although the front camera 21 is installed at the back side of the rear view mirror, the present disclosure is not limited thereto. For example, the front camera 21 may be directly attached to the top of the front windshield 20 inside the vehicle cabin. Although a single front camera 21 is provided in the first exemplary embodiment, two or more thereof may be provided according to their role.

Object detection by the front camera 21 enables objects to be identified, enabling vehicles, pedestrians, and the like to be detected and distinguished from other objects, and also enabling recognition of road signs and lane markings on the road surface.

A monocular camera is commonly employed as the front camera 21, which is employed for object detection. However, the front camera 21 is not limited to the monocular camera, and what is referred to as a stereo camera having the functionality of plural (for example two) cameras may be employed. A stereo camera may be employed to estimate the distance to objects based on the captured parallax.

When the camera lens, or a transparent cover (sensor face or imaging face) covering the camera lens from the front or the like, becomes dirty with mud or the like, this causes a shadow to be captured in images. Water droplet adherence is also conceivable during wet weather. This can render images unclear and hinder image analysis. There is accordingly a requirement to clean the camera lens or the transparent cover covering the camera lens from the front.

Wipers 40 and washer nozzles 40a are provided at a lower front portion of the front windshield 20 in order to clean the front windshield 20 disposed in front of the front camera 21. Cleaning liquid is sprayed through the washer nozzles 40a, and the wipers 40 are capable of wiping adhered material from the front windshield 20, including in front of the front camera 21.

A LIDAR (light detection and ranging/laser imaging detection and ranging) 26, a front grille camera 27, and a long-range millimeter wave radar 28 are provided at a central portion in front of a front grille 25. Medium range millimeter wave radars 29 and a pair of headlights 30 are provided at both ends in front of the front grille 25.

The LIDAR 26 is a sensor that, for example, emits infrared laser light pulses and measures distances based on the time taken for the laser light pulses to be reflected by objects and return. The LIDAR 26 is also capable of detecting the relative direction of objects by scanning while changing the direction of a narrowed infrared laser light using movable mirrors.

The LIDAR 26 employs infrared laser light, thereby enabling detection of objects with low reflectivity to radio waves, and in particular is capable of detecting objects that may obstruct travel, such as cardboard boxes, pieces of wood, or expanded polystyrene scattered on the road. The LIDAR 26 is also capable of not only object detection, but also detection of empty spaces between objects, due to its ability to detect the distances and relative directions of objects with high spatial resolution.

Since the LIDAR 26 is, for example, a sensor employing infrared light, the detection performance thereof may suffer if dirt adheres to the sensor face. There is accordingly a requirement to clean the sensor face of the LIDAR 26.

In the vehicle 210 of the first exemplary embodiment, a washer nozzle 26a to spray cleaning liquid toward the sensor face and an air nozzle 26b to blow air toward the sensor face are provided in the vicinity of the sensor face of the LIDAR 26 in order to clean the sensor face of the LIDAR 26.

The millimeter wave radars 28, 29 serve as radio wave sensors, and emit radio waves of very short wavelength, known as millimeter waves, and are capable of detecting the distance and directions of objects by detecting these radio waves returning after being reflected by the objects.

The millimeter wave radars 28, 29 perform detection using self-generated radio waves, enabling good detection characteristics to be maintained without being affected by light sources or weather and thus enabling accurate measurement of the distances to objects. In particular, the long-range millimeter wave radar 28 is capable of accurately detecting a vehicle ahead even when traveling through heavy rain, thick fog, or snow.

Since the millimeter wave radars 28, 29 employ radio waves, even if adhered material such as dirt or water droplets were to adhere to detection faces thereof, this would not impede detection as long as the radio waves were able to pass through. There is accordingly less of a necessity to provide cleaning sections to these detection faces. However, cleaning sections such as washer nozzles and air nozzles may be provided thereto if required.

The front grille camera 27 is provided at a central portion of the front grille 25. The front grille camera 27 enables objects to be identified, enabling vehicles, pedestrians, and the like to be detected and distinguished from other objects, and also enabling recognition of road signs and lane markings on the road surface. The front grille camera 27 may also be employed to provide an around view. When the lens of the front grille camera 27, or a transparent cover (sensor face or imaging face) covering the lens from the front or the like, becomes dirty with mud or the like, this causes a shadow to be captured in images. Water droplet adherence is also conceivable during wet weather. This can render images unclear and hinder image analysis. There is accordingly a requirement to clean the lens of the front grille camera 27 or the transparent cover covering the lens from the front.

A washer nozzle 27a that sprays cleaning liquid toward the lens or the cover of the front grille camera 27 and an air nozzle 27b that blows air toward the lens or the cover of the front grille camera 27 are thus provided to clean the lens or the cover of the front grille camera 27.

The headlights 30 are provided on both left and right sides in front of the front grille 25, and shine ahead of the vehicle 210 at night and in wet weather. The headlights 30 are provided in the vicinity of both ends of the front grille 25. Since the light level may become insufficient if the headlights 30 become dirty with mud or the like spraying up when traveling on rough roads, there is a requirement to provide cleaning sections thereto.

In the vehicle 210 of the first exemplary embodiment, a washer nozzle 30a that sprays cleaning liquid toward an illuminated face is provided in the vicinity of each of the headlights 30 in order to clean the illuminated face. Note that washer nozzles may also be provided to side marker lights, indicator lights and the like in addition to the headlights 30.

Door mirror cameras 36 are provided to door mirrors 35 of the vehicle 210 in order to image toward the rear, thereby enabling captured images to be displayed inside the vehicle for the driver. Downward-facing door mirror cameras 37 are also provided on the undersides of the door mirrors to enable detection of vehicles, pedestrians, and so on in the surroundings.

Although providing cleaning sections to the door mirror cameras 36 and the downward-facing door mirror cameras 37 is conceivable, such cleaning sections are not provided in the vehicle 210 of the first exemplary embodiment. However, cleaning sections such as air nozzles may be provided if required.

If necessary, cleaning sections such as air nozzles may also be provided to reflective faces of the door mirrors and fender mirrors. For example, air nozzles may be employed to blow air in order to drive off water droplets from the reflective faces of these mirrors in cases in which the mirrors become difficult to see due to water droplets or the like.

Side LIDARs 38 are provided at the sides of the vehicle 210 in order to enable detection of vehicles, pedestrians, and so on to the sides. Since the LIDARs are sensors that employ infrared light, for example, the detection performance thereof may suffer if dirt adheres to the sensor faces. There is accordingly a requirement to clean the sensor faces of the side LIDARs 38.

In the vehicle 210 of the first exemplary embodiment, a washer nozzle 38a to spray cleaning liquid toward the sensor face and an air nozzle (not illustrated in the drawings) to blow air toward the sensor face are provided in the vicinity of the sensor face of each of the side LIDARs 38 in order to clean the sensor faces of the side LIDARs 38.

Explanation follows regarding the cleaning sections of the rear control section 3.

A rear camera 46 is disposed at the inner side of an upper central portion of a rear windshield 45. The rear camera 46 is what is referred to as an interior mirror camera, and for example video from the rear camera 46 may be presented to the driver from the position of a back-side rear view mirror in place of a back-side rear view mirror. Moreover, an autonomous driving system is able to employ the rear camera 46 as an image sensor by performing image analysis on the video from the rear camera 46. The rear camera 46 may be provided with functionality of a camera employed to provide an around view.

In the vehicle 210 of the first exemplary embodiment, a washer nozzle 46a is provided at the upper center of the rear windshield 45, and a rear wiper 47 is provided at the lower center of the rear windshield 45, in order to clean the rear windshield 45 disposed on the imaging face side of the rear camera 46. Cleaning liquid is sprayed through the washer nozzle 46a, and the rear wiper 47 is capable of wiping dirt from the rear windshield 45, including at the imaging face side of the rear camera 46.

The rear camera 46 may alternatively be provided at a central portion of a rear bumper 50. In such cases, a washer nozzle that sprays cleaning liquid toward the lens face or the cover face and an air nozzle that blows air toward the lens face or the cover face may be provided in order to clean the lens face or the cover face of the rear camera 46.

A LIDAR 52 is provided at the center of the rear bumper 50. Since the LIDAR 52 is, for example, a sensor employing light such as infrared light, the detection performance thereof may suffer if adhered material such as dirt adheres to the sensor face.

In the vehicle 210 of the first exemplary embodiment, a washer nozzle 52a that sprays cleaning liquid toward the sensor face and an air nozzle 52b that blows air toward the sensor face are provided in the vicinity of the sensor face of the LIDAR 52 in order to clean the sensor face of the LIDAR 52.

Note that in the vehicle 210 of the first exemplary embodiment, side LIDARs 56 are provided at sides toward the rear in order to enable detection of vehicles, pedestrians, and so on to the sides toward the rear. A washer nozzle 56a that sprays cleaning liquid toward the sensor face and an air nozzle (not illustrated in the drawings) that blows air toward the sensor face are provided in the vicinity of the sensor face of each of the side LIDARs 56 in order to clean the sensor faces of the side LIDARs 56.

A rear camera 53 is provided at the center of the rear bumper 50. The rear camera 53 is employed to capture rearward images from the vehicle 210 to be displayed on a driving seat monitor when reversing. Note that the autonomous driving system may employ the rear camera 53 as an image sensor by performing image analysis on the video from the rear camera 53.

In the vehicle 210 of the first exemplary embodiment, a washer nozzle 53a that sprays cleaning liquid toward a lens face or a cover face, and an air nozzle 53b that blows air toward the lens face or the cover face are provided in the vicinity of the rear camera 53 in order to clean the lens face or the cover face of the rear camera 53.

Medium range millimeter radars 55 are provided in the vicinity of both ends of the rear bumper 50, or toward the rear of a rear fender. The medium range millimeter radars 55 are mainly employed to detect vehicles from the rear to the sides, or to measure the inter-vehicle distance.

Since millimeter wave radar employs radio waves, even if dirt were to adhere to detection faces thereof, this would not impede detection as long as the radio waves are able to pass through. There is accordingly less of a necessity to provide cleaning sections to these detection faces. In the first exemplary embodiment, cleaning sections are therefore not provided to the medium range millimeter radars 55. However, cleaning sections such as washer nozzles and air nozzles may be provided thereto if required.

Cleaning sections such as washer nozzles and air nozzles may also be provided to brake lights, rear indicator lights, and rear side marker lights if required. For example, air nozzles may be employed to blow air in order to drive off rainwater and mud in cases in which the brake lights are dirty with mud flicked up in wet weather.

Next, explanation follows regarding a washer device. A washer tank 12 serving as a reservoir is provided inside an engine compartment of the vehicle 210, and a level sensor 13 is provided to the washer tank 12 in order to detect the amount of cleaning liquid remaining in the washer tank 12. A front washer pump 14 to supply cleaning liquid from the washer tank 12 to a front multi-valve 16 is provided to the washer tank 12 or in the vicinity of the washer tank 12. A washer hose serving as a conduit provides a connection between the front washer pump 14 and the front multi-valve 16.

Similarly, a rear washer pump 15 to supply cleaning liquid from the washer tank 12 to a rear multi-valve 17 is provided to the washer tank 12 or in the vicinity of the washer tank 12. A washer hose serving as a conduit provides a connection between the rear washer pump 15 and the rear multi-valve 17.

Cleaning liquid is supplied from the washer tank 12 to the front multi-valve 16 by the front washer pump 14 via the washer hose. Plural valves capable of being individually open/close controlled are provided on the output side of the front multi-valve 16. The washer nozzle 26a for the LIDAR 26 provided at the central portion in the front of the front grille 25, the washer nozzle 27a for the front grille camera 27 provided at the central portion in front of the front grille 25, the washer nozzles 30a for the headlights 30 respectively provided on the left and right sides, the washer nozzles 38a to clean the sensor faces of the side LIDARs 38, and the washer nozzles 40a provided at the lower front of the front windshield are connected to the output sides of these respective valves via respective washer hoses serving as individual conduits. The cleaning liquid is supplied to the washer nozzle 26a, the washer nozzle 27a, the washer nozzles 30a, the washer nozzles 38a, and the washer nozzles 40a in a pressurized state, such that when the corresponding valve is controlled so as to open the cleaning liquid is sprayed toward the cleaning target through the corresponding washer nozzle 26a, 27a, 30a, 38a, or 40a.

The cleaning liquid is supplied from the washer tank 12 to the rear multi-valve 17 by the rear washer pump 15 via the washer hose. Plural valves capable of being individually open/close controlled are provided on the output side of the rear multi-valve 17. The washer nozzle 46a provided at the upper center of the rear windshield 45, the washer nozzle 52a to clean the sensor face of the LIDAR 52, the washer nozzle 53a to clean the lens face or the cover face of the rear camera 53, and the washer nozzles 56a to clean the sensor faces of the side LIDARs 56 are provided on the output sides of these respective valves via respective washer hoses serving as individual conduits. The cleaning liquid is supplied to the washer nozzles 46a, 52a, 53a, and 56a in a pressurized state, such that when the corresponding valve is controlled so as to open the cleaning liquid is sprayed toward the cleaning target through the corresponding washer nozzle 46a, 52a, 53a, or 56a.

Explanation follows regarding the air nozzles. In the front control section 2, the air nozzle 26b that blows air toward the sensor face of the LIDAR 26 provided at the central portion in front of the front grille 25, the air nozzle 27b that blows air toward the lens or the cover of the front grille camera 27 provided at the central portion in front of the front grille 25, and the air nozzles (not illustrated in the drawings) that blow air toward the sensor faces of the side LIDARs 38 are each connected to an air actuator air pump 41 through air hoses. Pressurized air is supplied to the respective air nozzles 26b, 27b, and so on through these air hoses by the air actuator air pump 41. Note that the front control section 2 may include a multi-valve that switches flow paths between the air actuator air pump 41 and the air nozzles 26b, 27b, and so on.

In the rear control section 3, the air nozzle 52b that blows air toward the sensor face of the LIDAR 52 provided at the center of the rear bumper 50, the air nozzle 53b that blows air toward the lens face or the cover face of the rear camera 53 provided at the center of the rear bumper 50, and the air nozzles (not illustrated in the drawings) for cleaning the sensor faces of the side LIDARs 56 are connected to an air actuator air pump 49 through air hoses. Pressurized air is supplied to the respective air nozzles 52b, 53b, and so on by the air actuator air pump 49 through air hoses.

Next, explanation follows regarding the control sections. Signals from the respective onboard sensors (the front camera 21, the LIDAR 26, and so on) are transmitted to an ADAS-ECU 10, serving as a driving assistance control device. The ADAS-ECU 10 employs these signals in the autonomous driving system. The ADAS-ECU 10 can also employ the signals transmitted from the respective onboard sensors to determine the necessity of cleaning the cleaning targets such as the sensor faces.

For example, when dirt adheres to the sensor face of a LIDAR, an output signal of the LIDAR characteristically only attenuates in response to an amount of dirt in the relative direction in which the dirt has adhered. Analyzing this characteristic enables determination to be made as to whether or not predetermined dirt has adhered to the sensor face of the LIDAR. When dirt adheres to the sensor face (camera imaging face) of a camera, for example, a specific fixed shadow only appears at the location where dirt has adhered. Analyzing the pattern of this specific shadow enables determination to be made as to whether or not the predetermined dirt has adhered to the sensor face of the camera. Analyzing the output signals of the respective onboard sensors in this manner enables determination to be made as to whether or not adhered material such as dirt has adhered to the sensor faces of the onboard sensors. Namely, the respective cameras and respective LIDARs correspond to adhered material detection sections of the present disclosure.

Note that adhered material detection sections (not illustrated in the drawings) may be provided as separate adhered material detection sections used to detect adhered material such as dirt on the sensor faces configuring the cleaning targets. For example, a separate adhered material detection section may be provided to detect dirt on the headlights. In such cases, detection signals of the adhered material detection sections are transmitted to the ADAS-ECU 10.

Furthermore, dirt may be determined to have adhered to the headlights by determining an illumination range and brightness (luminosity) of the headlights based on an image captured by the front camera 21. In such cases, there is no need to provide a separate adhered material detection section for the headlights.

Cleaning commands directed toward the respective cleaning sections output from the ADAS-ECU 10 are transmitted to a front wiper ECU 11 and a rear wiper ECU 48. Namely, cleaning control by the front control section 2 is performed by the front wiper ECU 11, and cleaning control by the rear control section 3 is performed by the rear wiper ECU 48.

A detection signal of the level sensor 13 is input to the front wiper ECU 11. The front wiper ECU 11 is connected to the front washer pump 14, the rear washer pump 15, and the front multi-valve 16 through signal lines and power source lines so as to be capable of controlling drive thereof. For example, the plural valves of the front multi-valve 16 can be individually open/close controlled by the front wiper ECU 11. The front wiper ECU 11 is also capable of controlling driving and stopping of the front washer pump 14 and the rear washer pump 15. The front wiper ECU 11 is also connected to the air nozzles 26b, 27b, and so on corresponding to the front control section 2 through signal lines and power source lines so as to be capable of individually controlling the air nozzles 26b, 27b, and so on. By controlling the wipers 40, the front wiper ECU 11 is also capable of wiping and cleaning the front windshield 20 using the washer nozzles 40a and the wipers 40 provided at the lower front portion of the front windshield.

The rear wiper ECU 48 is connected to the rear multi-valve 17 through signal lines and power source lines so as to be capable of controlling drive thereof. Namely, the plural valves of the rear multi-valve 17 can be individually open/close controlled by the rear wiper ECU 48. The rear wiper ECU 48 is also connected to the air nozzles 52b, 53b, and so on corresponding to the rear control section 3 through signal lines and power source lines so as to be capable of individually controlling the air nozzles 52b, 53, and so on. By controlling the rear wiper 47, the rear wiper ECU 48 is also capable of wiping and cleaning the rear windshield 45 using the washer nozzle 46a and the rear wiper 47 provided at the upper center of the rear windshield 45.

Note that in cases in which other cleaning sections not illustrated in FIG. 1 are also provided, cleaning sections corresponding to the front control section 2 are controlled by the front wiper ECU 11, and cleaning sections corresponding to the rear control section 3 are controlled by the rear wiper ECU 48.

In the vehicle 210 of the first exemplary embodiment, explanation is given in which the front control section 2 is controlled by the front wiper ECU 11, and the rear control section 3 is controlled by the rear wiper ECU 48. However, the present disclosure is not limited thereto. For example, the front control section 2 may be controlled by a control section separate to both the front wiper ECU 11 and the ADAS-ECU 10, and the rear control section 3 may be similarly controlled by a control section separate to both the rear wiper ECU 48 and the ADAS-ECU 10.

Although explanation is given in which the vehicle cleaning system 1 of the first exemplary embodiment includes two control sections, namely the front control section 2 and the rear control section 3, the present disclosure is not limited thereto. For example, the vehicle cleaning system 1 may be configured with three control sections corresponding to the front, sides, and rear, or may be configured with four or more control sections. Although the rear control section 3 of the first exemplary embodiment is disposed at the rear of the vehicle 210, there is no limitation thereto. For example, the rear control section 3 may be disposed at an upper central portion (at a vertical direction upper side) of the vehicle 210.

Although explanation is given in which the vehicle cleaning system 1 of the first exemplary embodiment is provided with a single washer tank 12, the present disclosure is not limited thereto. For example, separate washer tanks 12 may be disposed in accordance with the placement of the control sections (the front control section 2 and the rear control section 3) thereof. Specifically, one washer tank may be provided in the vicinity of the front control section 2, and another washer tank may be provided in the vicinity of the rear control section 3, to give a total of two washer tanks. This enables washer hoses providing front-to-rear connections in the vehicle 210 to be omitted, and also enables washer tank capacity to be increased. In cases in which plural washer tanks are provided, the washer tanks may be connected together through washer hoses such that cleaning liquid can be supplied from one washer tank to the other washer tank when either one of the washer tanks is running low on capacity.

Although explanation is given in which the front wiper ECU 11 controls driving and stopping of the rear washer pump 15 in the first exemplary embodiment, the present disclosure is not limited thereto. For example, the rear wiper ECU 48 may control driving and stopping of the rear washer pump 15. In such cases, although it is necessary to connect the rear wiper ECU 48 to the rear washer pump 15 with signal lines or power source lines, wiring can be kept shorter by for example employing disposing separate washer tanks 12 as described above.

Although the ADAS-ECU 10 employs signals transmitted from the respective sensors to determine the cleaning requirements of the cleaning targets configured by the sensor faces and the like in the first exemplary embodiment, the present disclosure is not limited thereto. For example, the front wiper ECU 11 and the rear wiper ECU 48 may perform some or all of the computation relating to determining the cleaning requirements. For example, if the front wiper ECU 11 and the rear wiper ECU 48 perform some of the computation relating to determining the cleaning requirements, the computational load on the ADAS-ECU 10 is alleviated commensurately. The computational load relating to determining the cleaning requirements may be allocated to the respective ECUs in accordance with the computational load situations of the respective ECUs.

Although the ADAS-ECU 10 employs signals transmitted from the respective sensors to determine the cleaning requirements of the cleaning targets configured by the sensor faces and the like in the first exemplary embodiment, the present disclosure is not limited thereto. For example, determination of the cleaning requirements may be performed in conjunction with determination of a dirtiness level. In such cases, cleaning levels may for example be adjusted according to the dirtiness levels.

The time at which to clean the cleaning targets such as the sensor faces is not limited to only:

(A) A timing at which cleaning targets are determined by the ADAS-ECU 10 based on detection signals output from the corresponding adhered material detection sections and cleaning commands for the respective cleaning sections are transmitted from the ADAS-ECU 10 to the front wiper ECU 11 and the rear wiper ECU 48.

The ADAS-ECU 10 is capable of ascertaining information such as a travel situation and an environmental situation, and may therefore employ such information to automatically decide a time to clean the cleaning targets such as the sensor faces. The travel situation includes information such as statuses of the vehicle 210 (information relating to the remaining cleaning liquid, ON and OFF states of an ignition switch, the vehicle type, and so on), and information relating to a travel direction, a travel speed, and a travel route (route classification such as “urban area” or “expressway”, congestion information, and so on). The environmental situation includes information relating to the weather, temperature, road conditions, and so on.

The times to clean the cleaning targets such as the sensor faces that are automatically decided by the ADAS-ECU 10 based on the travel situation and the environmental situation are not particularly limited, and examples thereof include:

(B) When the ignition switch is switched from OFF to ON.

(C) When rainfall has been detected.

(D) When travel at a predetermined speed has continued for a predetermined duration or longer.

(E) When the travel route has been determined to be a predetermined route.

(F) When the ADAS-ECU 10 has detected an emergency.

In such cases, cleaning commands may be issued simultaneously based on (A) to (F). For example, if a large quantity of mud has been flicked up due to traveling on rough roads in wet weather, cleaning commands may be issued for several of the cleaning targets at once when the vehicle 210 is started up after being parked for an extended period. In such cases, these several cleaning targets are cleaned in sequence. However, when cleaning of all of these several cleaning targets is desired, although the cleaning targets are cleaned in sequence, depending on the number of the cleaning targets a duration of from several seconds to several tens of seconds may be required from starting cleaning until cleaning of the final cleaning target is completed. Such a delay in cleaning is undesirable when cleaning safety-critical sensors such as collision avoidance sensors.

In the first exemplary embodiment, a cleaning priority ranking of the respective cleaning targets is set appropriately in accordance with the travel situation and the environmental situation. Namely, a cleaning priority ranking of the respective cleaning targets is set in accordance with the travel situation and the environmental situation, and cleaning commands are issued for each of the cleaning targets according to the priority ranking. In such cases, plural of the cleaning targets may have the same priority ranking as each other. Moreover, as a specific example of issuing cleaning commands to the respective cleaning targets according to the priority ranking, there is no limitation to only issuing cleaning commands for all of the cleaning targets, and in cases in which the remaining cleaning liquid is below a predetermined quantity, cleaning commands for cleaning targets with lower priority rankings may be cancelled.

Example 1 and Example 2 are now explained as specific examples of the first exemplary embodiment.

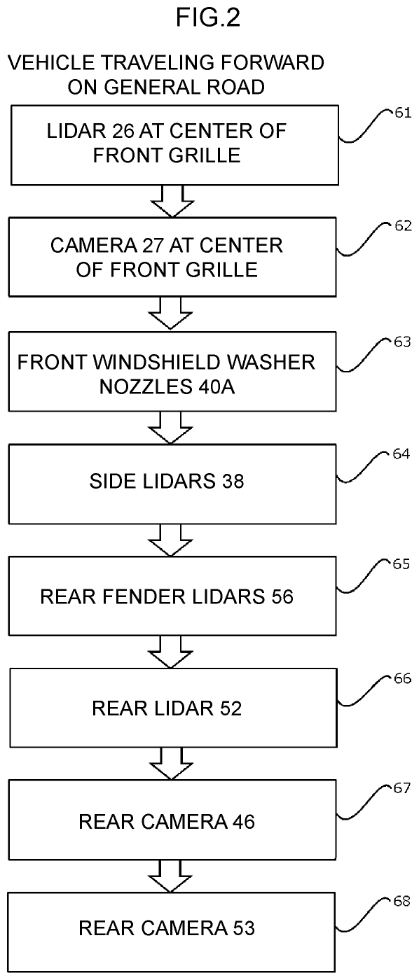

Explanation follows regarding Example 1, with reference to FIG. 2. FIG. 2 is a block diagram illustrating a cleaning section priority ranking for when traveling forward along a general road in the vehicle 210 of Example 1.

When the vehicle 210 is traveling forward along a general road, the priority ranking of the respective cleaning targets and the respective cleaning devices is as follows, ranked from (1-1) to (1-8), with (1-1) being the highest priority.

(1-1) LIDAR 26 at center of front grille (61)
(1-2) Camera 27 at center of front grille (62)
(1-3) Front windshield washer nozzles 40a (63)

### (1-4) Side LIDARs 38 (64)

(1-5) Rear fender LIDARs 56 (65)

### (1-6) Rear LIDAR 52 (66)

(1-7) Rear camera 46 (67)
(1-8) Rear camera 53 (68)

The LIDAR 26 at the center of the front grille is mainly employed for detection of obstacles ahead, detection of sudden incursions onto the road, and the like, and thus has the highest priority level when traveling forward along a general road from both the perspective of vehicle control and the perspective of safety.

The camera 27 at the center of the front grille is employed for detection of obstacles ahead, detection of traffic lanes and road signs, and the like, and thus has the second highest priority level when traveling forward along a general road from the perspective of vehicle control.

The front windshield washer nozzles 40a are employed together with the wipers 40 to secure the field of view of the driver, and also to clean adhered material from in front of the front camera 21 when installed at the top of the front windshield, and thus have the third highest priority level.

The side LIDARs 38 are required for detection of obstacles and the like at the sides of the vehicle when changing course, and are thus set with the fourth highest priority level.

The rear fender LIDARs 56 are required for detection of obstacles and the like at the rear and sides, and are thus set with the fifth highest priority level.

The rear LIDAR 52 is employed for detection of following vehicles and the like, and is less important when traveling forward, and is thus set with the sixth priority level.

The rear camera 46 is a camera employed as an interior mirror, and may be employed as an image sensor by performing image analysis on video from the rear camera 46. The rear camera 46 may also have the functionality of a camera employed to provide an around view, and is thus set with the seventh priority level.

The rear camera 53 is employed to capture images to the rear of the vehicle 210 for display on the driving seat monitor when reversing, and since it is less important to check video to the rear when traveling forward, is thus set with the eighth priority level.

Since the washer pumps have limited capacity, it may be difficult to spray cleaning liquid toward plural cleaning targets simultaneously. In such cases, for example, if cleaning requests for the LIDAR 26 at the center of the front grille and the side LIDARs 38 are generated at the same time when the vehicle 210 is traveling forward along a general road, the LIDAR 26 at the center of the front grille that has the higher priority level is cleaned first, and the side LIDARs 38 are cleaned next. Note that if extra washer pump capacity is available such that cleaning liquid can be sprayed toward two or more cleaning targets simultaneously, the two cleaning targets may be cleaned simultaneously according to the priority level sequence.

Moreover, for example, in cases in which a large quantity of muddy water hits the vehicle 210 when the vehicle 210 is traveling forward along a general road such that cleaning requests for all of the cleaning targets arise, the cleaning liquid is sprayed through the washer nozzles toward the cleaning targets in sequence from (1-1) to (1-8), namely in sequence from the highest priority level. Note that if extra washer pump capacity is available such that cleaning liquid can be sprayed toward two or more cleaning targets simultaneously, plural cleaning targets may be cleaned simultaneously according to the priority level sequence.

Regarding the air nozzles, in cases in which a common air pump is employed, since the air pump capacity is limited, it may be difficult to blow air toward plural cleaning targets simultaneously. In such cases, for example, if cleaning requests for the air nozzle 26b for the LIDAR 26 at the center of the front grille and the air nozzle 26b for the camera 27 at the center of the front grille are generated at the same time, first, air is blown toward the cleaning target through the air nozzle 26b for the LIDAR 26 at the center of the front grille that has a higher priority level, and next, air is blown toward the cleaning target through the air nozzle 27b for the camera 27 at the center of the front grille. Note that in cases in which it is possible to blow air toward two or more cleaning targets simultaneously, and in cases in which an individual air pump is provided for each cleaning target, air may be blown toward plural cleaning targets simultaneously based on a predetermined cleaning pattern according to the priority level sequence.

Since the system for the cleaning devices that spray cleaning liquid and the system for the cleaning devices that blow air are provided separately to each other, when cleaning targets are cleaned by blowing air in conjunction with cleaning by spraying cleaning liquid according to the priority ranking, for example, cleaning by blowing air toward a given cleaning target may be performed at a timing coinciding with cleaning by spraying cleaning liquid toward another cleaning target. For example, when a cleaning request for the LIDAR 26 at the center of the front grille and a cleaning request for the front grille camera 27 at the center of the front grille are generated at the same time, if a cleaning pattern for the respective cleaning locations is a pattern in which cleaning liquid is sprayed followed by blowing air, then:

(1) First, the LIDAR 26 at the center of the front grille is cleaned by spraying cleaning liquid through the washer nozzle 26a toward the LIDAR 26;

(2) Next, the LIDAR 26 at the center of the front grille is cleaned by blowing air through the air nozzle 26b toward the LIDAR 26, and when cleaning by the washer nozzle 26a finishes, cleaning of the camera 27 at the center of the front grille is then promptly started by spraying cleaning liquid through the washer nozzle 27a toward the camera 27, without waiting for the cleaning by the air nozzle 26b to finish;

(3) After the cleaning by the washer nozzle 27a has finished, and after cleaning of the LIDAR 26 by blowing air through the air nozzle 26b has finished, the camera 27 at the center of the front grille is cleaned by blowing air toward the camera 27 through the air nozzle 27b.

In this manner, the cleaning time of a given cleaning target by spraying cleaning liquid through the corresponding washer nozzle and the cleaning time of another cleaning target by blowing air through the corresponding air nozzle may overlap with each other. Note that this cleaning sequence is merely an example, and cleaning sequences of the present disclosure are not limited to this example. For example, a cleaning time of a given cleaning target by spraying cleaning liquid through the corresponding washer nozzle and a cleaning time of another cleaning target by blowing air through the corresponding air nozzle may be set so as not to overlap with each other.

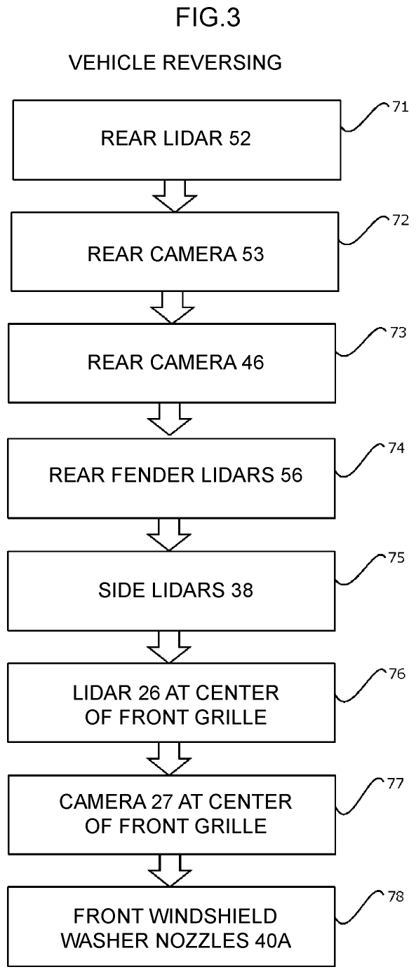

Next, explanation follows regarding Example 2, with reference to FIG. 3. FIG. 3 is a block diagram illustrating a priority ranking of cleaning targets in Example 2 (when the vehicle 210 is reversing). Explanation regarding elements that are similar to Example 1 will be omitted.

When the vehicle 210 is reversing, the priority ranking of the respective cleaning targets and the respective cleaning devices is as follows, ranked from (2-1) to (2-8), with (2-1) having the highest priority level.

### (2-1) Rear LIDAR 52 (71)

(2-2) Rear camera 53 (72)
(2-3) Rear camera 46 (73)
(2-4) Rear fender LIDARs 56 (74)

### (2-5) Side LIDARs 38 (75)

(2-6) LIDAR 26 at center of front grille (76)
(2-7) Camera 27 at center of front grille (77)
(2-8) Front windshield washer nozzles 40a (78)

The rear LIDAR 52 is employed for detection of obstacles to the rear, detection of sudden incursions onto the road, and the like, and thus has the highest priority level when the vehicle 210 is reversing from both the perspective of vehicle control and the perspective of safety.

The rear camera 53 is employed for capturing images to the rear of the vehicle 210 to be displayed on the driving seat monitor when reversing, and thus has the second highest priority level from the perspective of presenting the driver with video of the rear that is difficult for the driver to see.

The rear camera 46 is a camera employed as an interior mirror, and may be employed as an image sensor by performing image analysis on video from the rear camera 46. The rear camera 46 may also have the functionality of a camera employed to provide an around view, and is thus set with the third highest priority level.

The rear fender LIDARs 56 are employed to detect obstacles and the like at the rear and sides and are useful for obstacle detection when reversing, and thus have the fourth highest priority level.

The side LIDARs 38 are employed for detection of obstacles and the like at the sides and front and are also useful for obstacle detection when reversing, and thus have the fifth highest priority level.

The LIDAR 26 at the center of the front grille is employed for detection of obstacles ahead, detection of sudden incursions onto the road ahead, and the like. Since information regarding obstacles ahead of the vehicle 210 is less useful when reversing, the LIDAR 26 is set with the sixth priority level.

The front grille camera 27 at the center of the front grille is employed for forward video detection. Since video ahead of the vehicle 210 is less useful when reversing, the front grille camera 27 is set with the seventh priority level.

The front windshield washer nozzles 40a are employed together with the wipers 40 to secure the field of view of the driver ahead, and also affect video from the camera when installed at the top of the front windshield. Since the field of view ahead of the vehicle 210 and video ahead of the vehicle 201 is less useful when reversing, the washer nozzles 40a are set with the eighth priority level.

Note that Example 1 and Example 2 are merely examples, and the priority level settings may be modified and set as appropriate based on many factors in accordance with vehicle status and/or the environmental situation. For example, the front grille camera 27 at the center of the front grille (1-2) and the front windshield washer nozzles 40a (1-3) may have their priority levels reversed. In addition to the direction of progress as in the above examples, the priority ranking may be set in response to various factors relating to the vehicle status and/or the environmental situation, for example making travel route distinctions such as expressways, general roads (further distinctions being made within general roads, for example urban areas, bypasses, and suburbs), and based on congestion information, making distinctions based on the travel speed, making distinctions between fair, wet, and snowy weather, making distinctions based on the road conditions, making distinctions between cold-climate areas and warm-climate areas, and making distinctions based on vehicle type. Note that a distinction between fair, wet, and snowy weather is an example of weather information of the present disclosure.

For example, long-range sensors are set with a higher priority level on expressways than when traveling on general roads, and sensors involved in detecting sudden incursions are set with a higher priority level in urban areas. Moreover, long-range sensors are set with a higher priority level when the travel speed is high, and the camera-based sensors are set with a higher priority level during fair weather than during wet or snowy weather. Note that control relating to the priority ranking may be performed by the ADAS-ECU 10, or some or all of such control may be performed by the front wiper ECU 11 and the rear wiper ECU 48.

An alert section may also be provided to stop cleaning of a given cleaning target when a determination result that cleaning is required is not overturned even when the same cleaning target has been cleaned a predetermined number of times or greater (when adhered material cannot be removed), and to inform the driver that this cleaning target requires maintenance such as manual cleaning. This enables repeated frequent or continuous spraying of cleaning liquid through the washer nozzle and blowing of air through the air nozzle toward the cleaning target such as a sensor face to be prevented in cases in which adhered material cannot be removed automatically. Moreover, since the driver is notified that the adhered material cannot be removed automatically, the driver can be informed by this alert that a particular cleaning target requires manual cleaning. Note that in cases in which adhered material cannot be removed automatically, an announcement may be made to prompt safe travel, or the vehicle 210 may be (automatically) guided to a safe place.

The patterns for spraying cleaning liquid through the washer nozzles and the patterns for blowing air through the air nozzles may be modified in accordance with the cleaning target, the dirtiness level, the travel situation, and the environmental situation. For example, a cleaning level may be denoted high, medium, or low according to the length of time that the vehicle 210 has been parked. Alternatively, for example in cases in which dirtiness level information is appended to a cleaning request signal alongside the cleaning need, the cleaning level may be adjusted in accordance with the dirtiness level.

The following patterns are examples of cleaning patterns.

(a) A pattern of continuous spraying for a predetermined duration

(b) A pattern of plural repetitions of alternating spraying for a predetermined duration and resting for a predetermined duration

(c) A pattern of only spraying cleaning liquid through a washer nozzle

(d) A pattern of only blowing air through an air nozzle

(e) A pattern of spraying through a washer nozzle followed by blowing through an air nozzle

(f) A pattern of repeatedly spraying through a washer nozzle

(g) A pattern of repeatedly blowing air through an air nozzle

(h) A pattern of only driving the wipers or rear wiper

(i) A pattern of varying drive speed of the wipers or rear wiper and stoppage intervals of intermittent operation

(j) A pattern combining spraying of cleaning liquid through a washer nozzle and driving the wipers or rear wiper

(k) A pattern of adjusting a cleaning liquid spraying duration

(l) A pattern of varying cleaning liquid spray strength

(m) A pattern of adjusting an air blowing duration through an air nozzle

(n) A pattern of varying air blowing strength through an air nozzle

(o) A pattern of combining plural of the above patterns

For example, the greater the cleaning level, the longer the predetermined duration of (a), the greater the number of repetitions of (b), the greater the number of repetitions of (f), the greater the number of repetitions of (g), the faster the drive speed or the shorter the stoppage intervals of (i), the longer the spraying duration of (k), the stronger the spray strength of (l), the longer the spraying duration of (m), and the stronger the spray strength of (n).

Moreover, for example, as the pattern of repeatedly spraying through a washer nozzle of (f), various patterns may be provided, such as a pattern to perform precursory cleaning to moisten on the first occasion and perform main cleaning on the second occasion, a pattern to perform main cleaning on the first occasion and finishing cleaning on the second occasion, or a pattern to perform precursory cleaning to moisten on the first occasion, main cleaning on the second occasion, and finishing cleaning on the third occasion. Moreover, precursory cleaning and finishing cleaning may be set with shorter spraying durations and weaker spraying strength, while the main cleaning is set with a longer spraying duration and stronger spraying strength.

For example, a pattern may be set for one cleaning target location such that cleaning liquid is sprayed briefly on the first occasion, cleaning liquid is sprayed for longer on the second occasion, air is blown briefly through an air nozzle on the third occasion, and air is blown through the air nozzle for longer on the fourth occasion.

Regarding (l) and (n), the spraying strength may be modified as a function of time. As in (o), many different patterns can be set by combining patterns out of (a) through (n).

### Second Exemplary Embodiment

Explanation follows regarding a second exemplary embodiment of the present disclosure. Note that sections configured similarly to those of the first exemplary embodiment are allocated the same reference numerals, and explanation thereof is omitted.

In the vehicle 210 installed with the vehicle cleaning system 1, since cleaning of the cleaning targets such as the optical sensors is performed without the driver knowing, cleaning liquid may be consumed faster than the driver is aware, which may result in a cleaning liquid shortage. The second exemplary embodiment is provided with a mechanism to inform the driver of the remaining cleaning liquid level based on detection values of the level sensor 13 provided to the washer tank 12. This allows the driver to check the remaining cleaning liquid level at any time.

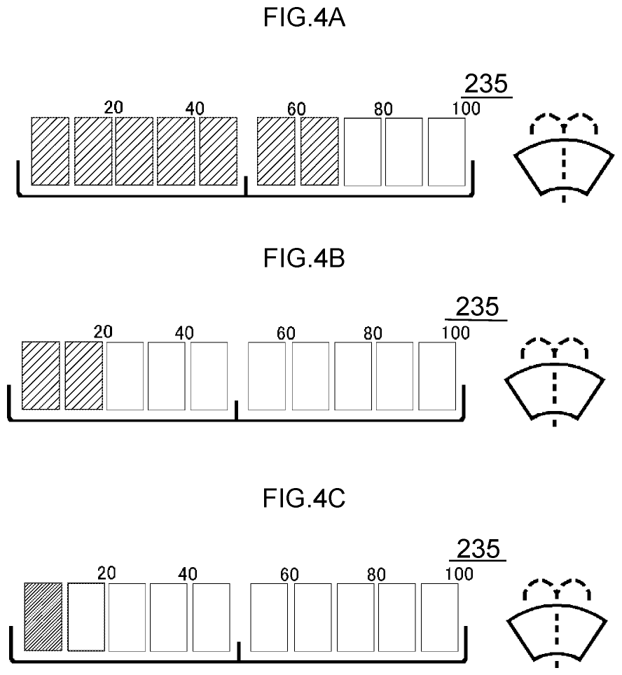

The vehicle 210 of the second exemplary embodiment is provided with a remaining level display section 235 (see FIG. 4A to FIG. 4C) to display the remaining cleaning liquid level in the washer tank 12 as detected by the level sensor 13 on an instrument panel (not illustrated in the drawings). The remaining level display section 235 display is, for example as illustrated in FIG. 4A, a bar-type display with ten gradations, such that the remaining cleaning liquid level in the washer tank 12 is displayed at all times. Note that FIG. 4A illustrates an example of display of the remaining level display section, FIG. 4B illustrates an example of display when the remaining cleaning liquid level is at a predetermined value or higher, and FIG. 4C illustrates an example of display when the remaining cleaning liquid level has fallen below the predetermined value and display is emphasized.

The capacity of the washer tank 12 of the vehicle 210 is around 3 to 5 liters. Due to space constraints in the engine compartment, larger capacities than this are difficult to accommodate. In the autonomously driven vehicle 210 of the second exemplary embodiment, a large number of optical sensors are employed, and there is consequently a large number of washer nozzles that spray cleaning liquid. When dirt adheres to the detection faces (sensor faces) of the onboard optical sensors during autonomous driving, there is a concern that detection precision of the onboard optical sensors may suffer, rendering autonomous driving impossible. Moreover, since cleaning operations are performed automatically when dirt is detected to have adhered to the onboard optical sensors, the cleaning liquid may be used faster than the driver anticipates.

In the vehicle cleaning system 1 of the second exemplary embodiment, the driver or another occupant is able to check the remaining cleaning liquid level displayed on the remaining level display section 235 at any time, thus enabling cleaning liquid to be replenished in a timely manner when a cleaning liquid shortage is predicted, and enabling a situation in which a remaining cleaning liquid shortage prevents use of cleaning liquid to be suppressed. Note that the remaining level display color on the remaining level display section 35 is preferably changed between cases in which the remaining cleaning liquid level is at the predetermined value or greater (see FIG. 4A and FIG. 4B. FIG. 4A illustrates an example of display in a case in which the remaining cleaning liquid level is 60% or greater but less than 70%, and FIG. 4B illustrates an example of display in a case in which the remaining cleaning liquid level is the predetermined value of 10% or greater but less than 20%), and cases in which the remaining cleaning liquid level has fallen below the predetermined value (see FIG. 4C). Employing a flashing display or the like to emphasize display is also preferable. This enables the driver or other occupant to reliably ascertain that a state has arisen in which the cleaning liquid needs replenishing.

Note that the liquid surface of the cleaning liquid in the washer tank 12 fluctuates constantly during acceleration and deceleration of the autonomously driven vehicle 210, as well as due to slopes and bumps on the road surface. Accordingly, if the remaining liquid level detected by the level sensor 13 is displayed as is, the remaining level display will jump around, making it more difficult for the driver or other occupant to ascertain the remaining cleaning liquid level. Accordingly, applying a hysteresis property to the remaining level display stabilizes the display, making it easier for the driver or other occupant to ascertain the remaining cleaning liquid level. This hysteresis property may be applied appropriately during signal processing within the level sensor 13, or during signal processing by the ADAS-ECU 10 or a separate ECU.

In the autonomously driven vehicle 210 of the second exemplary embodiment, an alert section is preferably provided to alert the occupant in some way when adhesion of dirt to the onboard optical sensors is detected and an automatic cleaning operation is performed. When such an alert is issued, the driver or other occupant is able to ascertain that automatic cleaning is being performed, enabling the driver or other occupant to be suppressed from being startled or unsettled by automatic cleaning suddenly being performed with sudden operational noise from the washer pumps and the like. In particular, in cases such as that of the front camera 21, in which the cleaning target is an onboard sensor provided on the vehicle cabin inside of the front windshield 20, suddenly spraying cleaning liquid onto the front windshield in the field of view of the driver or other occupant and then suddenly wiping the front windshield with the front wipers would greatly startle the driver or other occupant. However, since the driver or other occupant is able to ascertain through an alert that automatic cleaning (in this case, spraying of cleaning liquid and wiping with the front wipers) is to be performed, startling the driver or other occupant is avoided. Note that such an alert can easily be generated by the ADAS-ECU 10 or a separate ECU.

Such an alert should be conveyed through the senses of the driver or other occupant, and may be optical (visual), acoustic (auditory), or vibratory (haptic) in nature. Optical alerts include display and flashing of warning lights, display on the instrument panel or head-up display that automatic cleaning is to be performed, or display on a car navigation system (a display used for display in the car navigation system) that automatic cleaning is to be performed, implemented by working in coordination with the car navigation system, described below. Acoustic alerts include not only simple alert sounds, but also audio informing that automatic cleaning is to be performed. Vibratory alerts may be performed by vibrating a seat or steering wheel.

The car navigation system employing a satellite-based positioning system (for example a global positioning system (GPS)) that computes the current placement of the vehicle based on positioning signals received from positioning satellites is installed in the autonomously driven vehicle 210. The car navigation system is provided with functionality to automatically compute a travel route and distance between the current location and an input destination. The vehicle 210 is also installed with the autonomous driving system, namely a system that enables settings for autonomous driving, namely an autonomous driving system that sets a current location, destination, travel route, and so on. In the autonomously driven vehicle 210 of the second exemplary embodiment, the autonomous driving system and the car navigation system work in coordination with each other to compute a predicted cleaning liquid consumption amount corresponding to the travel distance and travel route to the destination input to the autonomous driving system and the car navigation system. In cases in which the remaining cleaning liquid level is insufficient for the predicted cleaning liquid consumption amount, or in cases in which the remaining cleaning liquid level will fall below the predetermined value, an alert is preferably issued by the alert section.

Namely, it is possible to predict the amount of cleaning liquid that will be required up to a destination based on the relationship between past travel distances and travel routes and cleaning liquid usage amounts, and the relationship between pre-accumulated travel distances and travel routes and cleaning liquid usage amounts. Accordingly, when a destination is input to the autonomous driving system and the car navigation system, since the predicted cleaning liquid consumption amount is known immediately, whether or not the remaining cleaning liquid level will be sufficient for the predicted consumption amount is also known immediately. If necessary, the cleaning liquid consumption amount may be predicted taking driving conditions such as the weather into consideration. For example, the cleaning liquid consumption amount differs between expressway travel in fair weather and travel on general roads in wet weather. In cases in which the remaining cleaning liquid level is insufficient compared to the predicted cleaning liquid consumption amount, and in cases in which the remaining cleaning liquid level will fall below the predetermined value, an alert is issued by the alert section. The driver or other occupant is able to replenish the cleaning liquid in response, such that even in the case of autonomous driving, a situation in which the autonomous driving is impeded due to insufficient cleaning liquid can be forestalled.

In such cases, the alert section preferably issues alerts in plural stages in response to the remaining cleaning liquid level, and for example issues alerts when the remaining cleaning liquid level reaches 50%, 30%, and 10%. Such a configuration enables the driver or other occupant to check the level of urgency of cleaning liquid replenishment using a display section. By issuing different alerts according to the remaining cleaning liquid level, the driver or other occupant is able to immediately ascertain the level of urgency of cleaning liquid replenishment from the type of alert.

In such cases, the alert may be optical, acoustic, or vibratory in nature. In the case of an optical alert, a lamp flashing speed may be changed in accordance with the level of urgency, the level of urgency itself may be displayed on an instrument panel or head-up display, or the level of urgency itself may be displayed on the car navigation system by working in coordination with the car navigation system. In the case of an acoustic alert, the type, volume, or pattern of an alert sound may be changed in accordance with the level of urgency, or the level of urgency itself may be informed using audio. In the case of a vibratory alert, a vibration intensity, vibration duration, or vibration pattern of a seat or the steering wheel may be changed in accordance with the level of urgency.

Note that since the driver or other occupant may be startled if an alert is suddenly issued while the vehicle 210 is traveling, preferably configuration is made such that alerts are only issued when necessary, in consideration of the driving conditions of the vehicle 210, for example such that alerts are only issued when the vehicle 210 starts traveling or when the vehicle 210 is stationary.

Moreover, the remaining cleaning liquid level may be displayed only at a timing when it is more likely to be noticed by the driver by displaying only when necessary in consideration of the driving conditions of the vehicle 210, such as only displaying before the vehicle 210 starts traveling or is stationary, or displaying by working in coordination with the car navigation system.

Note that in the second exemplary embodiment, explanation has been given regarding a case in which the autonomously driven vehicle 210 is a four-wheeled vehicle. However, two-wheeled vehicles may also be installed with driving assistance systems such as collision avoidance systems and automated cleaning systems. The present disclosure may be applied to two-wheeled vehicles installed with such a driving assistance system if they include onboard optical sensors.

In the second exemplary embodiment, explanation has been given regarding a case in which sprayed sections serving as targets include at least one out of a light, a mirror, or a sensor face (sensing face) of a LIDAR, a camera, a camera sensor, an image sensor, an infrared sensor, or millimeter wave radar. However, the present disclosure may also be applied to targets other than those mentioned above.

In the second exemplary embodiment, the washer pumps are controlled to automatically spray cleaning liquid toward a sprayed section when adhered material adhering to the surface of the sprayed section has been detected by an adhered material detection section. However, there is no limitation thereto. For example, programming may be performed in advance such that the washer pumps are controlled to spray cleaning liquid onto sprayed sections at predetermined timings. Note that when the washer pumps are actuated at predetermined timings, an alert regarding the actuation of the washer pumps may be issued by the alert section.

In the second exemplary embodiment, explanation has been given regarding the example of the autonomously driven vehicle 210. However, the present disclosure is not limited thereto. The vehicle cleaning system of the present disclosure may, for example, be widely applied to vehicles provided with washer nozzles to spray cleaning liquid, vehicles provided with optical sensors, and vehicles installed with driving assistance systems (in particular, vehicles installed with driving assistance systems such as collision avoidance systems or automated cleaning systems).

Modified Example of Second Exemplary Embodiment

In the second exemplary embodiment, the remaining cleaning liquid level in the washer tank 12 is displayed on the remaining level display section 235 provided in the vehicle 210 in order to advise the driver of the remaining cleaning liquid level. As a modified example of the second exemplary embodiment, the remaining cleaning liquid level in the washer tank 12 may be reported to a user information terminal (for example a smartphone) via an onboard communication device and a base station communication device.

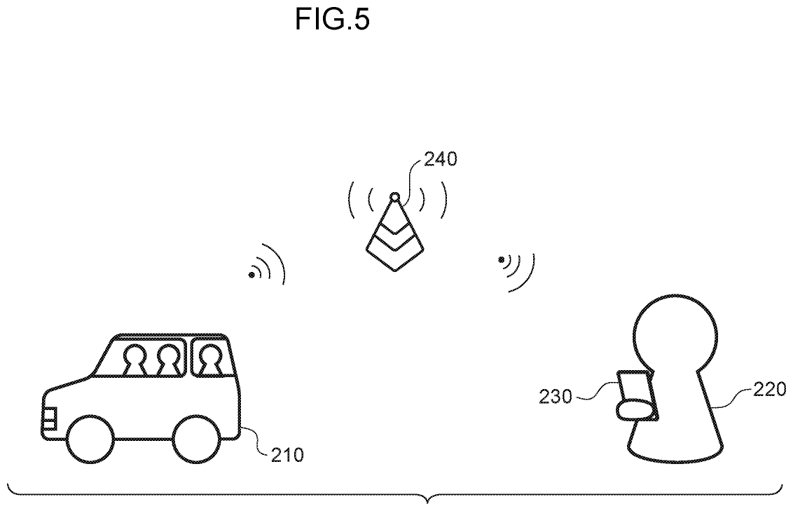

Explanation follows regarding basic configuration of the modified example of the second exemplary embodiment, with reference to FIG. 5. As illustrated in FIG. 5, the vehicle 210 is connected to a terminal device 230 carried by a user 220 via a base station 240 so as to be capable of wireless communication therewith. The terminal device 230 is a smartphone, for example, provided with a display screen to display various information. The user 220 is able to obtain information relating to the remaining cleaning liquid level in the washer tank 12 of the vehicle 210 by referring to the display screen of the mobile terminal 230.

The user 220 is, for example, the owner of the vehicle 210, and is not on board the vehicle 210. In such cases, even though the user 220 is not able to look at the remaining level display section 235 on the instrument panel (not illustrated in the drawings) in the vehicle 210, the user 220 can easily look at the terminal device 230. The user 220 who owns the vehicle 210 may, for example, be a car-sharing service provider. In such cases, although the user 220 does not drive the vehicle 210 themselves, it is necessary for the user 220 to check that the cleaning liquid in the washer tank 12 of the vehicle 210 does not become insufficient for the sake of service customers driving the vehicle 210.

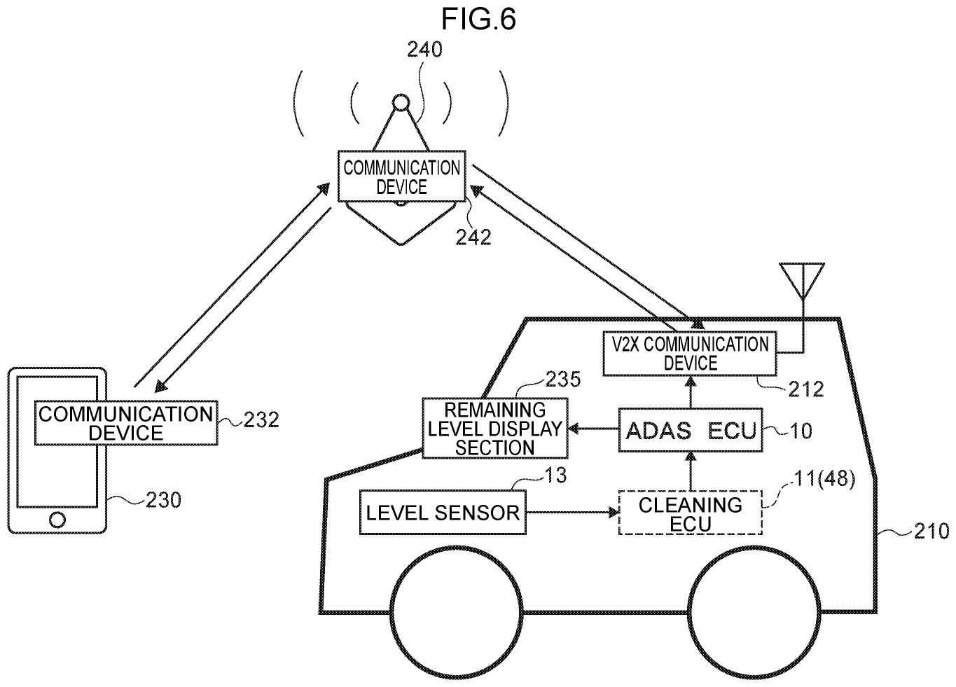

FIG. 6 is a block diagram illustrating an example of hardware configuration of respective devices in the modified example of the second exemplary embodiment. Detailed explanation follows regarding the modified example of the second exemplary embodiment, with reference to FIG. 6.

As illustrated in FIG. 6, the vehicle 210 is provided with the respective configurations illustrated in FIG. 1, similarly to the first exemplary embodiment. For ease of explanation, only the ADAS-ECU 10, the level sensor 13, and the cleaning ECUs 11 (48) are illustrated. The cleaning ECUs 11 (48) is a collective term referring to the front wiper ECU 11 and the rear wiper ECU 48. The vehicle 210 also includes the remaining level display section 235 described in the second exemplary embodiment. The vehicle 210 is also provided with a vehicle-to-everything (V2X) communication device 212. The V2X communication device 212 is an example of a communication device of the vehicle 210, although any device capable of communicating with the terminal device 232 via the base station 240 may be employed as the communication device of the vehicle 210.

As illustrated in FIG. 6, the terminal device 230 includes a communication device 232. The base station 240 includes a communication device 242. The communication device 232 of the terminal device 230 is capable of exchanging data with the V2X communication device 212 of the vehicle 210 via the communication device 242 of the base station.

Information relating to the remaining cleaning liquid level in the washer tank 12 as detected by the level sensor 13 of the vehicle 210 is displayed on the remaining level display section 235 similarly to in the second exemplary embodiment, and is also transmitted to the base station 240 from the V2X communication device 212. The communication device 242 of the base station 240 receives the information from the V2X communication device 212 of the vehicle 210, and transmits this information to the terminal device 230 either in response to a request from the terminal device 230, or unprompted. The terminal device 230 displays the remaining cleaning liquid level in the washer tank 12 of the vehicle 210 on the display screen based on the information received from the base station 240 via the communication device 232. For example, the display screen of the terminal device 230 may display an image such as that illustrated in FIG. 4A to FIG. 4C, similarly to the remaining level display section 235, although there is no limitation thereto. The display screen of the terminal device 230 may be configured so as to display images representing information relating to the remaining cleaning liquid level in the washer tank 12 of the vehicle 210 in various forms according to the needs of the user 220.

Similarly to in the second exemplary embodiment, the terminal device 230 may be configured so as to issue various alerts to the user 220 based on the received information relating to the remaining cleaning liquid level in the washer tank 12.

In the modified example of the second exemplary embodiment, the user can be advised of a situation in which cleaning liquid replenishment is required, and be prompted to replenish the cleaning liquid, even when the user is not on board the vehicle. Moreover, in the case of car-sharing, the service customer driving the vehicle is not the owner of the vehicle, and cleaning liquid replenishment is normally performed by the service provider who owns the vehicle. In the modified example of the second exemplary embodiment, the car-sharing service provider can be advised of a situation in which cleaning liquid replenishment is required for each of plural vehicles owned by the car-sharing service provider.

### Third Exemplary Embodiment

Explanation follows regarding a third exemplary embodiment of the present disclosure. Note that sections configured similarly to those of the first exemplary embodiment are allocated the same reference numerals, and explanation thereof is omitted.

Configuration of a vehicle cleaning system 1 of a vehicle 210 according to the third exemplary embodiment is similar to that of the first exemplary embodiment. In the vehicle cleaning system 1 of the third exemplary embodiment, the front wiper ECU 11 and the rear wiper ECU 48 are provided independently of the ADAS-ECU 10. Explanation follows from the perspectives of control of the cleaning sections corresponding to the front control section 2 by the front wiper ECU 11, and control of the cleaning sections corresponding to the rear control section 3 by the rear wiper ECU 48.

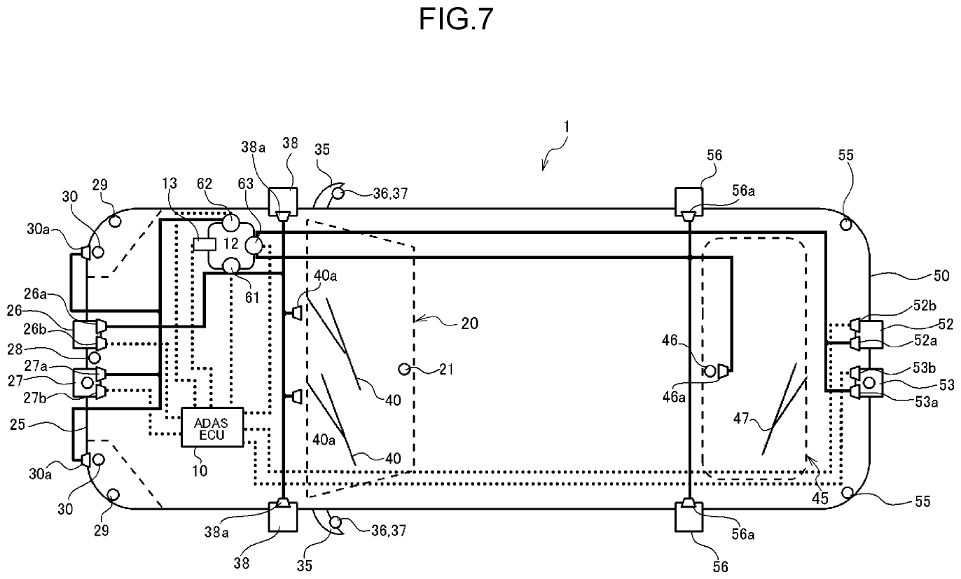

FIG. 7 illustrates a comparative example in order to explain operation of the third exemplary embodiment. Explanation follows regarding the comparative example, with reference to FIG. 7. Note that FIG. 7 is a schematic plan view illustrating a vehicle cleaning system according to the comparative example. In FIG. 7, configuration sections equivalent to those of the exemplary embodiments of the present disclosure illustrated in FIG. 1 are allocated the same reference numerals, and detailed explanation thereof is omitted. In FIG. 7, the bold solid lines represent washer hoses, and the bold dashed lines represent power source lines or signal lines. Air hoses are omitted from illustration in FIG. 7.

In a vehicle of the comparative example, first to third washer pumps 61 to 63 are provided to the washer tank 12 or in the vicinity of the washer tank 12. The first washer pump 61 is commonly connected to the washer nozzle 26a for the LIDAR 26 provided at the central portion in front of the front grille 25, the washer nozzles 38a for the side LIDARs 38 provided at the sides of the vehicle, and the washer nozzles 40a provided at the front lower portion of the front windshield 20. The second washer pump 62 is commonly connected to the washer nozzle 27a for the front grille camera 27 provided at the central portion in front of the front grille 25, and the washer nozzles 30a for the headlights 30 on both the left and right sides. The third washer pump 63 is commonly connected to the washer nozzle 46a provided at the upper center of the rear windshield 45, the washer nozzles 56a for the side LIDARs 56 provided to the sides toward the rear, the washer nozzle 52a for the LIDAR 52 provided at the center of the rear bumper 50, and the washer nozzle 53a for the rear camera 53 provided at the center of the rear bumper 50.

In the comparative example, the first to third washer pumps 61 to 63 are each commonly connected to plural washer nozzles. Accordingly, when a washer pump is actuated, cleaning liquid is sprayed through all of the commonly connected washer nozzles, resulting in greater cleaning liquid consumption.

In the comparative example, since the first to third washer pumps 61 to 63 are connected to the respective washer nozzles through washer hoses, the number of washer hoses increases, and the hose length increases.

As is clear from FIG. 7, all of the cleaning sections are controlled by the ADAS-ECU 10 in the comparative example. Accordingly, multiple signal lines and power source lines are concentrated on the ADAS-ECU 10 in the comparative example, making wiring more difficult. Moreover, the number of signal lines and power source lines increases, and the signal line and power source line lengths increase.

In addition, when the ADAS-ECU 10 performs control computation for the autonomous driving system in the comparative example, the ADAS-ECU 10 also controls all of the cleaning sections. This leads to an increase in the load on the ADAS-ECU 10 as a result of implementing this additional functionality, such that there is a concern that the processing functions of the ADAS-ECU 10 may suffer or malfunction.

Next, explanation follows regarding operation of the vehicle cleaning system 1 of the third exemplary embodiment.

The ADAS-ECU 10 employs signals transmitted from the respective onboard sensors to determine the cleaning requirements of the cleaning locations such as the sensor faces. When cleaning is required, the cleaning sections corresponding to the cleaning locations that require cleaning are identified, and the ADAS-ECU 10 transmits control commands to drive the identified cleaning sections to either the front wiper ECU 11 or the rear wiper ECU 48. When this is performed, the cleaning sections corresponding to the front control section 2 are controlled by the front wiper ECU 11, and the cleaning sections corresponding to the rear control section 3 are controlled by the rear wiper ECU 48.

This enables automatic control of the cleaning sections, thereby enabling adhered material such as dirt on the sensor faces of the sensors required for autonomous driving to be cleaned (removed) without the driver knowing. Accordingly, the likelihood of impeding autonomous driving or driving assistance due to a deterioration in the detection performance of these sensors can be reduced. Moreover, the sensors can be cleaned automatically without the driver knowing.

Since the ADAS-ECU 10 uses signals transmitted from the respective sensors to determine the cleaning needs of the cleaning locations such as the sensor faces, only the cleaning locations that require cleaning can be appropriately identified.

The amount of wiring between the front wiper ECU 11 and the cleaning sections corresponding to the front control section 2 and the amount of wiring between the rear wiper ECU 48 and the cleaning sections corresponding to the rear control section 3 can be reduced in comparison to the comparative example, and the wiring distance can also be shortened.

By dividing the vehicle cleaning system 1 into the front control section 2 and the rear control section 3, the number of washer hoses between the pumps and the washer nozzles can be reduced in comparison to the comparative example, and the hose length can also be shortened.

In the vehicle cleaning system 1 of the third exemplary embodiment, control of the front control section 2 is performed by the front wiper ECU 11, and control of the rear control section 3 is performed by the rear wiper ECU 48, thereby enabling the computational load on the ADAS-ECU 10 to be suppressed from increasing. Moreover, since the existing front wiper ECU 11 and rear wiper ECU 48 can be employed in the cleaning system control, there is no need to provide additional ECUs solely for cleaning.

In the third exemplary embodiment, it is sufficient simply to apply cleaning command wiring to the front wiper ECU 11 and the rear wiper ECU 48. Accordingly, the concentration of signal lines or power source lines at the ADAS-ECU 10 can be reduced in comparison to the comparative example, and the wiring length of such signal lines or power source lines can be shortened.

Washer tanks 12 may be distributed in accordance with the placement of the control sections. Specifically, one washer tank may be provided for the front control section 2, and one washer tank may be provided for the rear control section 3, to give a total of two washer tanks. This enables washer hoses providing front-to-rear connections in the vehicle 210 to be omitted, and also enables washer tank capacity to be increased.

Moreover, for example, the rear wiper ECU 48 may control driving and stopping of the rear washer pump 15. In such cases, although signal lines or power source lines are required to connect the rear wiper ECU 48 to the rear washer pump 15, in cases in which the washer tanks 12 are placed so as to be distributed as described above, for example, the wiring can be shortened.

The front multi-valve 16 and the rear multi-valve 17 that switch flow paths are provided so as to be distributed at the front control section 2 and the rear control section 3. This distributed placement of the front multi-valve 16 and the rear multi-valve 17 enables wiring and tubes to be omitted, or enables the lengths of such wiring and tubes to be shortened, in particular the front multi-valve 16 and the rear multi-valve 17 are placed so as to be distributed in accordance with the distributed placement of the front wiper ECU 11, the rear wiper ECU 48, and the washer tanks 12. Functional and logical distributed placement of the front wiper ECU 11, the rear wiper ECU 48, the washer tank 12, the front multi-valve 16, and the rear multi-valve 17 is also possible in accordance with the placement of the cleaning locations.

The front multi-valve 16 and the rear multi-valve 17 are each provided with plural valves capable of being individually open/close controlled by the front wiper ECU 11 and the rear wiper ECU 48. Accordingly, cleaning liquid can be conveyed to each of the washer nozzles individually, and spraying of cleaning liquid from each of the washer nozzles can be controlled individually. This enables cleaning liquid consumption to be greatly reduced in comparison to the comparative example.

The cleaning targets are not limited to optical devices including optical sensors such as LIDARs, cameras, headlights, camera sensors, image sensors, and infrared sensors, as well as lights such as headlights and mirrors such as door mirrors, and may also include radar such as millimeter wave radar and non-optical sensors such as ultrasound sensors. Since various sensors may be included in the cleaning targets, the vehicle cleaning system 1 of the third exemplary embodiment is particularly useful in vehicles installed with autonomous driving systems.

Moreover, by consolidating control of the front control section 2 in the front wiper ECU 11 and consolidating control of the rear control section 3 in the rear wiper ECU 48, control of the front control section 2 and control of the rear control section 3 can be aggregated to enable more efficient control, thereby enabling control algorithms to be simplified, and enabling computational load to be reduced.

The cleaning sections include washer nozzles, air nozzles, combinations of washer nozzles and air nozzles, and combinations of wipers and washer nozzles. Cleaning liquid is sprayed through the washer nozzles and air is blown through the air nozzles onto the respective cleaning faces in response to drive commands transmitted from the front wiper ECU 11 and the rear wiper ECU 48 through the signal lines or power source lines.

The wipers 40 are controlled by the front wiper ECU 11 and the rear wiper 47 is controlled by the rear wiper ECU 48 so as to wipe the front windshield 20 or the rear windshield 45 at predetermined speeds and intervals. The wiping speed and intervals when this is performed are variably controlled by the front wiper ECU 11 and the rear wiper ECU 48.

Similarly to in the first exemplary embodiment, in the vehicle 210 of the third exemplary embodiment the cleaning priority ranking, cleaning sequence, cleaning timings, and need for an alert may be decided as appropriate according to the situation.

Although not described in the vehicle 210 of the respective exemplary embodiments, ultrasound sensors may, for example, be installed at the front, rear, or sides of a vehicle. Ultrasound sensors detect obstacles such as other vehicles by emitting ultrasound to their surroundings, and are mainly employed to detect vehicles entering a traffic lane during travel. Ultrasound sensors are also employed for obstacle detection in parking assist systems. Since ultrasound sensors employ sound waves, as long as the sound waves can be transmitted, obstacle detection is possible even if, for example, dirt has adhered to the sensor face. The cleaning requirements of the sensor faces of ultrasound sensors are therefore low. However, cleaning sections such as washer nozzles or air nozzles may be provided as required.

Note that the air nozzles 26b, 27b, and the air nozzles 52b, 53b of the exemplary embodiments respectively blow air that has been conveyed under pressure by the air actuator air pump 41 and the air actuator air pump 49 toward their respective cleaning targets. However, the present disclosure is not limited thereto. For example, a single air actuator air pump may be provided for each air nozzle, or a single air actuator air pump may be provided at both the vehicle front and the vehicle rear. In cases in which a single air actuator air pump is provided at both the vehicle front and the vehicle rear, air is supplied from the air pump provided at the vehicle front to the air nozzles disposed at the vehicle front, and air is supplied from the air pump provided at the vehicle rear to the air nozzles disposed at the vehicle rear.

Note that the positions of the respective onboard sensors disposed in the vehicle are not limited to the positions described in the exemplary embodiments. For example, although a camera (namely, the front grille camera 27) is provided to the front grille 25, such a camera may be provided to the front bumper. Although a camera (namely, the rear camera 53) is provided at the center of the rear bumper 50, such a camera may be provided to a rear grille. In each of the exemplary embodiments, an example is given in which the front multi-valve 16 and the rear multi-valve 17 are provided. However, the present disclosure is not limited thereto. For example, instead of such multi-valves, plural valves may be provided to the front washer pump 14 and the rear washer pump 15 respectively, with each of these plural valves being controlled by the front wiper ECU 11 or the rear wiper ECU 48 to supply cleaning liquid to predetermined washer nozzles.

The disclosure of Japanese Patent Application No. 2017-237731, filed on Dec. 12, 2017, the disclosure of Japanese Patent Application No. 2017-197285, filed on Oct. 10, 2017, and the disclosure of Japanese Patent Application No. 2017-237729, filed on Dec. 12, 2017, are incorporated in their entirety by reference herein.

All cited documents, patent applications, and technical standards mentioned in the present specification are incorporated by reference in the present specification to the same extent as if each individual cited document, patent application, or technical standard was specifically and individually indicated to be incorporated by reference.

1. A vehicle cleaning system comprising:
a plurality of cleaning sections configured to clean cleaning targets including a sensor face of an optical sensor installed at a vehicle; and
a control section capable of automatically controlling the cleaning sections,
the control section being configured to control a priority ranking for actuation of the cleaning sections in response to at least one of a travel situation or an environmental situation of the vehicle, in a case in which a cleaning request has been made for the cleaning sections.

2. The vehicle cleaning system of claim 1,
wherein the control section is configured to actuate the cleaning sections in sequence according to the priority ranking in cases in which cleaning requests have been made for the plurality of cleaning sections at substantially the same time.

3. The vehicle cleaning system of claim 1, further comprising an adhered material detection section configured to detect an adherence state of adhered material to the cleaning targets, wherein:
the control section is configured to determine the cleaning request and control the cleaning sections based on an adhered material detection signal from the adhered material detection section.

4. The vehicle cleaning system of claim 3,
wherein an alert is issued in cases in which the adhered material detection signal has been emitted by the adhered material detection section after cleaning has been performed a predetermined number of times or greater within a predetermined duration.

5. The vehicle cleaning system of claim 1,
wherein the control section is configured to control the priority ranking in response to a direction of progress of the vehicle.

6. The vehicle cleaning system of claim 1,
wherein the control section is configured to control the priority ranking in response to weather information.

7. The vehicle cleaning system of claim 1,
wherein the control section is configured to control the priority ranking in response to a travel speed of the vehicle.

8. The vehicle cleaning system of claim 1,
wherein the control section is configured to control the priority ranking in response to a travel route of the vehicle.

9. The vehicle cleaning system of claim 1,
wherein the control section is configured to control an actuation pattern of the cleaning sections.

10. The vehicle cleaning system of claim 9, wherein:
each cleaning section includes a sprayer section configured to spray a fluid toward a corresponding cleaning target; and
the actuation pattern includes a spraying period and a rest period of the fluid.

11. The vehicle cleaning system of claim 1, wherein each cleaning section further includes:
a washer nozzle configured to spray cleaning liquid toward a corresponding cleaning target;
a washer pump configured to supply the cleaning liquid to the washer nozzle;
a washer tank configured to hold the cleaning liquid;
a liquid level detection section configured to detect a remaining level of the cleaning liquid in the washer tank; and
a remaining level display section configured to display the remaining level of the cleaning liquid in the washer tank as detected by the liquid level detection section.

12. The vehicle cleaning system of claim 11,
wherein the remaining level display section exhibits a hysteresis property when displaying the remaining level of the cleaning liquid in the washer tank as detected by the liquid level detection section.

13. The vehicle cleaning system of claim 11, further comprising a first alert section configured to compute a predicted consumption amount of the cleaning liquid corresponding to a travel distance to an input destination, and to issue an alert in a case in which the remaining level of the cleaning liquid is insufficient compared to the predicted consumption amount of the cleaning liquid, or in a case in which a predetermined remaining level value or lower will be reached.

14. The vehicle cleaning system of claim 11, further comprising a second alert section configured to issue alerts in a plurality of stages, in response to the remaining level of the cleaning liquid.

15. The vehicle cleaning system of claim 14,
wherein the second alert section issues different alerts corresponding to the remaining level of the cleaning liquid.

16. The vehicle cleaning system of claim 1,
wherein the control section is provided separately from a driving assistance control device that performs computation processing on signals from the optical sensor.

17. The vehicle cleaning system of claim 16,
wherein a plurality of the control sections are provided in a distributed placement.

18. The vehicle cleaning system of claim 17,
wherein the control sections are placed so as to be at least distributed at a vehicle front and a vehicle rear.

19. The vehicle cleaning system of claim 16,
wherein the control section doubles as a wiper control device.

20. The vehicle cleaning system of claim 1,
wherein the vehicle is installed with a driving assistance device or an autonomous driving device.
